(19) United States
(12) Patent Application Publication
(10) Pub. No.: US 2005/0274626 A1
(43) Pub. Date: Dec. 15, 2005

(54) Polishing pad and polishing method

(75) Inventor: Shigeru Tominaga, Tokyo (JP)

Correspondence Address: STAAS & HALSEY LLP, SUITE 700, 1201 NEW YORK AVENUE, N.W., WASHINGTON, DC, 20005, US

(73) Assignee: ROKI TECHNO CO., LTD., Tokyo (JP)

(21) Appl. No.: 11/145,179

(22) Filed: Jun. 6, 2005

(30) Foreign Application Priority Data
Nov. 4, 2003 (JP) 2003-374352

(51) Int. Cl. B23H 3/00

(52) U.S. Cl. 205/654

(57) ABSTRACT

A polishing pad for electrolytically polishing an interconnect material of a device wafer by applying a direct-current voltage to the interconnect material as an anode and a cathode as a counter electrode while causing an electrolyte to come in contact with the anode and the cathode, the polishing pad includes a plurality of electrolytic cells formed by the anode, the cathode, and the electrolyte and having a contact surface smaller than the device wafer, the electrolytic cells being moved relative to the interconnect material when electrolytically polishing the interconnect material on the device wafer. The polishing pad includes an insulating member having a plurality of openings, a conductive top layer provided on the insulating member and having a plurality of openings communicating with the openings in the insulating member, and a conductive sheet formed on the insulating member on a side opposite to the conductive top layer, wherein the electrolyte reception section is formed by the opening in the insulating member and the opening in the conductive top layer.

### BACKGROUND OF THE INVENTION

The present invention relates to a polishing pad and a polishing method suitable for electrochemically polishing an interconnect material on a device wafer.

Along with an increase in the degree of integration and scaling down of size of semiconductor devices, a multilevel interconnect technology has been employed. In the process of forming a pattern of an interconnect material, this pattern is formed on the surface of a semiconductor wafer. The interconnect material is then covered with a film of an insulating material such as silicon oxide, and an additional pattern of the interconnect material is formed on the insulating material. These steps are repeatedly performed.

In this process of forming a pattern of the interconnect material, plug holes and interconnect grooves are formed in an insulator such as silicon oxide (hereinafter called “interlayer dielectric”) by etching or the like. The plug holes and the interconnect grooves are simultaneously filled with a copper interconnect material, and unnecessary copper on the surface is removed by chemical mechanical polishing (hereinafter called “CMP”) to achieve planarization.

In order to reduce power consumption and increase the operational speed of the semiconductor devices, use of a low-dielectric-constant material for the interlayer dielectric has been studied. However, since the low-dielectric-constant material exhibits inferior mechanical strength and chemical stability, the copper interconnect material may be removed from the interlayer dielectric due to friction force caused by the rotational speed and the polishing pressure used in the CMP process. Therefore, a ultra-low-pressure CMP process in which the polishing pressure is significantly reduced has been proposed. However, since the ultra-low-pressure CMP process has drawbacks such as a decrease in the polishing rate and uniformity, electrochemical polishing (hereinafter called “ECP”) or the like has been studied instead of the CMP process.

ECP is a method in which a direct current is caused to flow between an anode formed of a copper interconnect material on the wafer surface and a separately provided cathode through an electrolyte to electrochemically dissolve and remove the copper interconnect material from the wafer surface.

In related-art ECP, since the copper interconnect material on the wafer surface is used as the anode, it is necessary to directly connect the electrode with the interconnect material (including Cu seed layer). In the case of using a platen rotary type polishing device, since the wafer is provided to a polishing head and pressed against a polishing pad, it is difficult to secure a space for causing the electrode to directly come in contact with the interconnect material. Therefore, it is difficult to employ ECP or use ECP in combination with CMP.

In the polishing process for the copper interconnect material, since a barrier metal must be polished in addition to the copper interconnect material, multistage (several steps) polishing is performed. For example, the polishing process for the copper interconnect material includes a first step of removing the copper interconnect material, a second step of removing the barrier metal, and, as required, a third step of removing the copper interconnect material and the interlayer dielectric. As the CMP device, a multi-platen/multi-head type CMP device has been mainly used. However, use of ECP in combination with CMP increases the size and cost of the CMP device.

### OBJECTS AND SUMMARY OF THE INVENTION

An object of the invention is to provide a polishing pad and a polishing method used for electrochemical polishing which can prevent a decrease in the polishing rate and uniformity.

A first invention provides a polishing pad for electrolytically polishing an interconnect material on a device wafer by applying a direct-current voltage to the interconnect material as an anode and a cathode as a counter electrode while causing an electrolyte to come in contact with the anode and the cathode, the polishing pad comprising: a plurality of electrolytic cells formed by the anode, the cathode, and the electrolyte and having a contact surface smaller than the device wafer, the electrolytic cells being moved relative to the interconnect material when electrolytically polishing the interconnect material on the device wafer.

A second invention provides the polishing pad as defined in the first invention, comprising: a plurality of electrolyte reception sections disposed between the anode and the cathode and filled with the electrolyte so that the electrolyte comes in contact with the anode and the cathode, the electrolyte reception sections forming the electrolytic cells.

A third invention provides the polishing pad as defined in the second invention, comprising: an insulating member having a plurality of openings; and a conductive top layer provided on the insulating member and having a plurality of openings communicating with the openings in the insulating member; wherein the electrolyte reception section is formed by the opening in the insulating member and the opening in the conductive top layer.

A fourth invention provides the polishing pad as defined in the third invention, comprising: a conductive bottom layer provided on the insulating member on a side opposite to the conductive top layer.

A fifth invention provides the polishing pad as defined in the third invention, wherein the conductive top layer includes a polishing material.

A sixth invention provides the polishing pad as defined in the third invention, wherein the insulating member has a thickness of 0.5 to 5 mm.

A seventh invention provides the polishing pad as defined in the third invention, wherein a positive electrode of a direct-current power supply is connected with the conductive top layer, and the interconnect material is caused to function as the anode by causing the conductive top layer to be electrically connected with the interconnect material on the device wafer.

An eighth invention provides a polishing method for electrolytically polishing an interconnect material on a device wafer by applying a direct-current voltage to the interconnect material as an anode and a cathode as a counter electrode while causing an electrolyte to come in contact with the anode and the cathode, the method comprising: forming a plurality of electrolytic cells having a contact surface smaller than the device wafer using the anode, the cathode, and the electrolyte; and electrolytically polishing the interconnect material on the device wafer while relatively moving the electrolytic cells and the interconnect material.

A ninth invention provides the polishing method as defined in the eighth invention, comprising: using a polishing pad including a plurality of electrolyte reception sections forming the electrolytic cells.

A tenth invention provides the polishing method as defined in the ninth invention, comprising: placing the polishing pad on a platen of a polishing device; and supplying the electrolyte to the polishing pad.

An eleventh invention provides the polishing method as defined in the tenth invention, comprising: rotating the platen and a polishing head of the polishing device while causing the interconnect material on the device wafer secured to the polishing head to come in contact with the electrolytic cells.

A twelfth invention provides the polishing method as defined in the tenth invention, comprising: electrolytically polishing the interconnect material while supplying a direct current by applying a positive potential to an electrode in contact with the polishing pad and applying a negative potential to the platen.

A thirteenth invention provides the polishing method as defined in the eighth invention, wherein the electrolyte includes a polishing material dispersed therein.

### BRIEF DESCRIPTION OF THE DRAWINGS

FIG. 1 is an oblique diagram showing an embodiment of a polishing pad according to the invention.

FIG. 2 is a cross-sectional diagram along the line II-II shown in FIG. 1.

FIG. 3 is an oblique diagram showing a polishing device using an embodiment of the polishing pad according to the invention.

FIG. 4 is a diagram illustrative of an embodiment of a polishing method using the polishing pad according to the invention.

FIG. 5 is an enlarged diagram of a section V shown in FIG. 4.

FIG. 6A is a schematic diagram showing a state in which a copper interconnect material is polished, and FIG. 6B is a schematic diagram showing a state in which electrolytic polishing has reached an interconnect groove upper section of an interlayer dielectric as a result of electrolytic polishing of the copper interconnect material shown in FIG. 6A.

FIG. 7 shows constant current Cu electrolytic polishing characteristics obtained in Measurement Example 1.

FIG. 8 shows electrolysis voltage dependence of Cu electrolytic polishing obtained in Measurement Example 2.

FIG. 9 shows a platen rotation dependence of Cu electrolytic polishing obtained in Measurement Example 2.

### DESCRIPTION OF PREFERRED EMBODIMENT

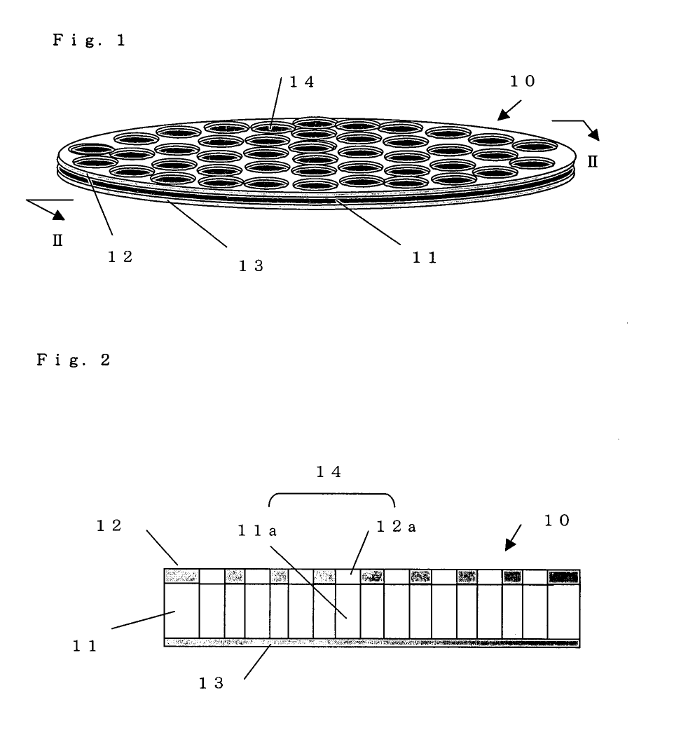

An embodiment of a polishing pad according to the invention is described below with reference to the drawings. FIG. 1 is an oblique diagram showing an embodiment of a polishing pad according to the invention. FIG. 2 is a cross-sectional diagram along the line 11-11 shown in FIG. 1. A polishing pad 10 in this embodiment includes an insulating layer 11, a conductive top layer 12, a conductive sheet 13, and the like. The polishing pad 10 is used in a state in which the polishing pad 10 is attached to a platen 21 using a conductive adhesive tape (not shown) (see FIG. 3).

The insulating layer 11 is a disk made of an insulating material, and has a plurality of through-holes 11a formed therein. As the material for the insulating layer 11, a synthetic resin exhibiting electrical insulating properties, and preferably a foam structure exhibiting viscoelasticity may be suitably used. The insulating layer 11 preferably has a thickness of about 0.5 to 5 mm.

The conductive top layer 12 is a layer formed of a conductive material provided on the surface of the insulating layer 11, and has through-holes 12a communicating with the through-holes 11a in the insulating layer 11. As the material for the conductive top layer 12, a conductive nonmetal sheet such as nonwoven fabric or fabric made of conductive fiber is preferably used.

As the material for the conductive top layer 12, the above-mentioned nonmetal sheet impregnated with a thermosetting resin or an elastomer may also be used. In this case, it is preferable to use a material obtained by dispersing polishing abrasive in a thermosetting resin or an elastomer, since the surface roughness of the electrochemically polished surface is reduced to obtain a mirror-finish surface. The conductive top layer 12 may be formed by alternately arranging the above-mentioned nonmetal sheet and a sheet containing polishing abrasive perpendicularly to the polishing surface. As the abrasive, silicon oxide, aluminum oxide, iron oxide, zinc oxide, silicon carbide, boron carbide, or synthetic diamond powder may be used either individually or in combination of two or more.

The conductive sheet (conductive bottom layer) 13 is a sheet made of a conductive material provided on the back side of the insulating layer 11. As the material for the conductive sheet 13, a metal material or a nonmetal material may be used without specific limitations insofar as the material is insoluble in an electrolyte. As such a material, carbon, graphite, stainless steel, and the like can be given.

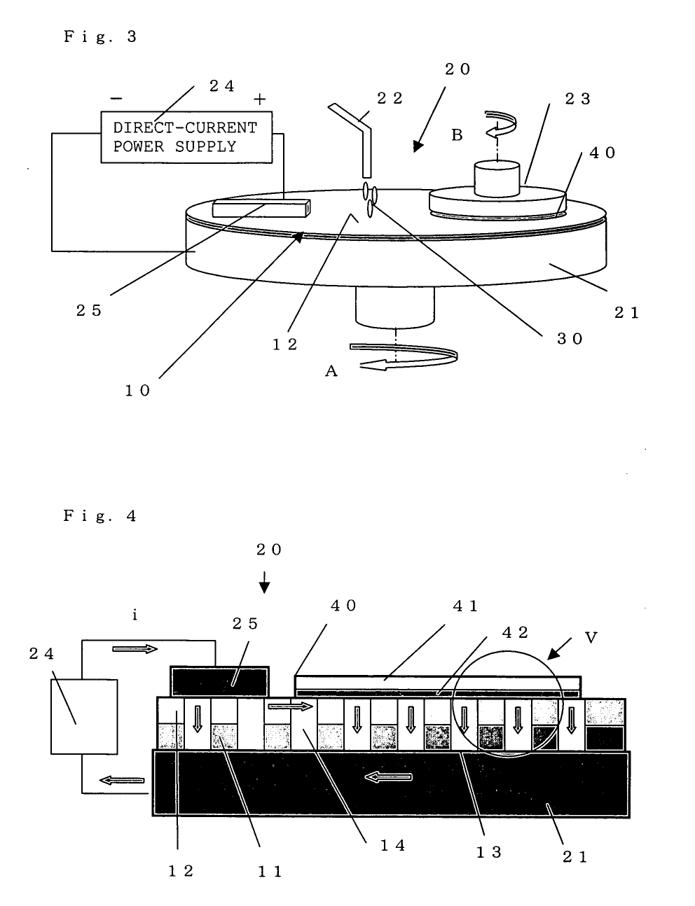

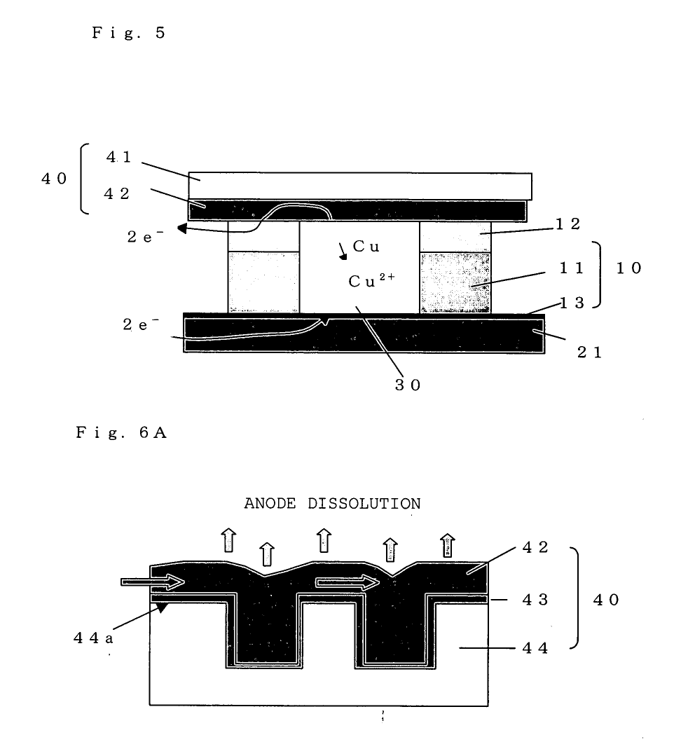

The polishing pad 10 includes an electrolyte reception section 14 in which the through-hole 11a in the insulating layer 11 communicates with the through-hole 12a in the conductive top layer 12 and which forms an electrolytic cell which receives an electrolyte 30 (see FIGS. 4 and 5) during polishing. As the electrolyte reception sections 14, it suffices that a plurality of openings be formed in the polishing pad 10. In this embodiment, the electrolyte reception section 14 is formed as an opening having a circular horizontal cross section. However, the shape of the electrolyte reception section 14 is not particularly limited insofar as the through-hole 11a communicates with the through-hole 12a. The horizontal cross section of the electrolyte reception section 14 may be polygonal. The electrolyte reception section 14 may be formed as a ring-shaped or narrow rectangular opening instead of a circular or polygon opening.

In the case where the electrolyte reception section 14 is a circular through-hole, the electrolyte reception section 14 preferably has a diameter of 0.5 to 100 mm. It is preferable that the ratio of the total open area of the electrolyte reception sections (electrolytic cells) 14 to the total area of the polishing pad 10 be 50 to 80%. This is because the polishing efficiency is decreased if the ratio is too low and the electrical resistance of the conductive top layer 11 is considerably increased if the ratio is too high.

FIG. 3 is an oblique diagram showing a polishing device using an embodiment of the polishing pad according to the invention. A polishing device 20 includes a platen 21, a nozzle 22, a polishing head 23, a direct-current power supply 24, a contact electrode 25, and the like. The platen 21 is a member which rotates at a low speed in the direction indicated by an arrow A, and the polishing pad 10 is secured on the upper surface of the platen 21 with the conductive top layer 12 facing upward. The nozzle 22 is a member which is disposed above the polishing pad 10 and supplies the electrolyte 30. The polishing head 23 is a member to which a wafer 40 is secured and which rotates in the direction indicated by an arrow B. In the wafer (device wafer) 40, a copper interconnect material (polishing target surface) 42 is formed on the bottom surface of a silicon substrate 41 (see FIG. 4). The wafer 40 is disposed so that the copper interconnect material 42 comes in contact with the conductive top layer 12 of the polishing pad 10. The direct-current power supply 24 provides electricity in a state in which the contact electrode 25 connected with a positive electrode is in contact with the conductive top layer 12 and a negative electrode is connected with the platen 21.

FIG. 4 is a diagram illustrative of an embodiment of a polishing method using the polishing pad according to the invention, and FIG. 5 is an enlarged diagram of a section V shown in FIG. 4. In this polishing method, the polishing target surface (copper interconnect material 42) of the wafer 40 is caused to come in contact with the conductive top layer 12 of the polishing pad 10, and the polishing target surface is polished by rotating the platen 21 and the polishing head 23 while supplying the electrolyte 30. A direct current is applied in a state in which the conductive top layer 12 is connected with the positive electrode of the direct-current power supply 24 by causing the contact electrode 25 to come in contact with the conductive top layer 12 and the negative electrode is connected with the platen 21.

FIG. 4 schematically shows enlarged cross sections of the platen 21, the polishing pad 10, and the wafer 40. The copper interconnect material 42 on the wafer 40, which is electrically connected with the contact electrode 25 through the conductive top layer 12, functions as an anode when the positive electrode of the direct-current power supply 24 is connected with the contact electrode 25, and the platen 21 connected with the negative electrode functions as a cathode, whereby electrolytic cells are formed by the electrolyte 30 provided in the through-holes 11a and 12a (electrolyte reception sections 14). At the anode, the copper interconnect material 42 on the wafer 40 is dissolved and removed through an electrochemical reaction indicated by Cu→Cu²⁺+2 e⁻.

In the polishing pad 10, the electrons generated from the copper interconnect material 42 as the anode are consumed by a Cu deposition reaction and a hydrogen generation reaction at the cathode on the surface of the conductive sheet 13, whereby an electric circuit is formed. This causes electrolysis of the copper interconnect material 42 to proceed.

In the polishing method in this embodiment, the rotation of the platen 21 and the polishing head 23 causes the through-holes 11a and 12a formed in the polishing pad 10 to be moved relative to the copper interconnect material 42 as the anode at a relative rotational speed of the platen 21 to the polishing head 23. Therefore, since the electrolyte 30 in the through-holes 11a and 12a is always replaced, the electrolyte concentration in the vicinity of the copper interconnect material 42 and the concentration of metal ions such as copper ions from the copper interconnect material 42 are maintained constant, whereby the surface of the copper interconnect material 42 can be uniformly subjected to electrolytic polishing.

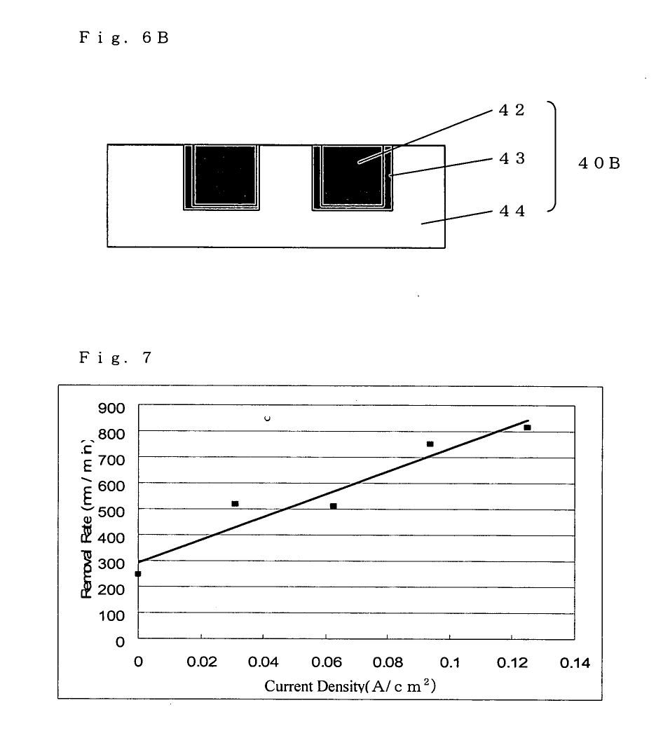

Since the anode is formed by causing the copper interconnect material 42 to come in contact with the conductive top layer 12, the contact area is extremely reduced when electrolytic polishing has reached an interconnect groove upper section 44a of an interlayer dielectric 44 as a result of polishing the copper interconnect material 42 shown in FIG. 6A. Therefore, since the electrolytic current is reduced due to an increase in the electric resistance, the degree of electrolytic polishing is decreased. This prevents the interconnect material in the interconnect grooves from being polished, whereby polishing as shown in FIG. 6B can be achieved.

FIG. 6B is a diagram showing a state in which electrolytic polishing has reached the interconnect groove upper section 44a of the interlayer dielectric 44 as a result of electrolytic polishing of the copper interconnect material 42 shown in FIG. 6A. When electrolytic polishing has progressed as shown in FIG. 6B, the copper interconnect material 42 is electrically isolated, whereby the electric path disappears and dissolution of the anode stops.

A barrier metal 43 is provided in order to prevent the metal atoms in the copper interconnect material 42 from migrating to the interlayer dielectric 44. As the material for the barrier metal 43, a material having a comparatively high resistivity and exhibiting conductivity, such as a metal nitride, for example, tantalum nitride or titanium nitride, may be used. In the case of forming a multilevel interconnect, since an interlayer dielectric is further deposited on the structure shown in FIG. 6B, the barrier metal 43 on the upper surface is removed in order to secure strength.

The embodiments of the invention are described below in more detail by measurement examples.

### MEASUREMENT EXAMPLE 1

Constant current Cu electrolytic polishing characteristics were measured by the electrolytic polishing method shown in FIG. 4 using a polishing pad in which through-holes with a diameter of 5 mm were formed at a pitch of 10 mm. The results are shown in FIG. 7. As the electrolyte, an electrolyte prepared by diluting commercially available reagent grade phosphoric acid 50 times was used. The rotational speeds of the platen and the polishing head were set at 45 rpm, and the polishing pressure was set at 18.7 g/cm².

In FIG. 7, the removal rate (RR) at a current density (current per unit area of Cu plated substrate with dimensions of 40×40 mm) of “0” indicates the polishing rate when electrolysis is not performed, that is, the etching rate. Therefore, a value obtained by subtracting the etching rate from the polishing rate at each current density indicates the removal rate due to electrolysis.

As is clear from the results shown in FIG. 7, the removal rate (RR) of the Cu plated substrate is linearly increased as the current density is increased.

### MEASUREMENT EXAMPLE 2

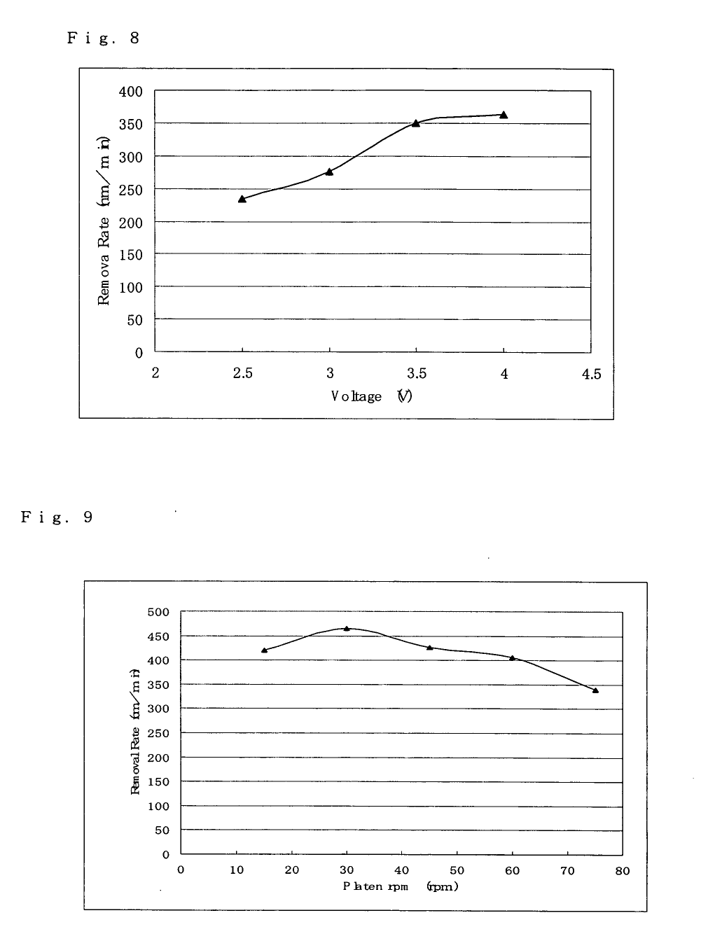

An electrolysis voltage dependence of constant voltage Cu electrolytic polishing was measured by the electrolytic polishing method shown in FIG. 4. The results are shown in FIG. 8. As the electrolyte, an electrolyte prepared by diluting commercially available reagent grade phosphoric acid 50 times was used. The rotational speeds of the platen and the polishing head were set at 45 rpm, and the polishing pressure was set at 18.7 g/cm².

As is clear from the results shown in FIG. 8, an electrolytic polishing effect is observed at a power supply voltage of about 3 V or more, even if the etching rate shown in FIG. 7 is taken into consideration.

FIG. 9 shows the measurement results for effects of the platen rotational speed when using an electrolyte prepared by diluting commercially available reagent grade phosphoric acid 10 times as the electrolyte. As is clear from the results shown in FIG. 9, the removal rate is decreased as the platen rotational speed is increased. The accuracy of the polishing surface was excellent at a rotational speed of about 40 rpm or more and was insufficient at a rotational speed of about 40 rpm or less. It is considered that these results may vary depending on the diameter and the pitch of the through-holes formed in the pad.

As described above, according to this embodiment, since the copper interconnect material is indirectly used as the anode by causing the conductive top layer of the polishing pad to come in contact with the copper interconnect material on the device wafer, and the platen is used as the cathode to form the electrolytic cells, it is unnecessary to cause the electrode to directly come in contact with the copper interconnect material on the lower surface of the wafer secured to the polishing head. This makes it unnecessary to provide a special device for causing the electrode to directly come in contact with the outer circumference edge of the wafer. Therefore, the electrochemical polishing method can be employed using a platen rotary type polishing device used for the CMP process.

As a result, since one platen/head of multi-platen/multi-heads can be used for electrochemical polishing using a related-art platen rotary type polishing device, polishing in several steps can be performed using a single device. Therefore, a reduction in the size and cost of the device can be achieved.

Moreover, a reduction in the polishing rate, which is the drawback of ultra-low-pressure CMP, can be prevented, and uniform polishing can be achieved by electrochemically dissolving and removing unnecessary copper interconnect material on the surface of the device wafer by forming the electrolytic cells so that the electrolytic cells can be moved relative to the device wafer.

This embodiment prevents a decrease in the electrolyte concentration in the vicinity of the interconnect material by forming the electrolytic cells so that the electrolytic cells can be moved relative to the polishing target material, realizes uniform polishing by preventing an increase in the amount of metal ions (e.g. Cu ions) of the interconnect material in the electrolyte in the vicinity of the interconnect material, and makes it unnecessary to cause the electrode to directly come in contact with the interconnect material by forming the electrolytic cells.

The invention is not limited to the above-described embodiments, and various modifications and variations may be made. Such modifications and variations are also within the scope of equivalence of the invention.

(1) The conductive sheet and the adhesive tape for securing the polishing pad to the platen protect the platen or the like from contamination due to Cu deposition or the like. The conductive sheet may be omitted when using a conductive adhesive tape.

(2) The above-described embodiment illustrates an example in which the electrolyte reception sections are moved relative to the interconnect material. However, the device wafer may be rotated or regularly moved horizontally while fixing the counter electrode (e.g. platen) and the polishing pad, or the platen to which the polishing pad is secured and a running belt (counter electrode) may be rotated or moved horizontally. However, both the device wafer and the counter electrode may be moved.

(3) The above-described embodiment illustrates an example in which the polishing abrasive is dispersed in the conductive top layer. However, a polishing material such as silicon oxide may be dispersed in the electrolyte 30.

1. A polishing pad for electrolytically polishing an interconnect material on a device wafer by applying a direct-current voltage to the interconnect material as an anode and a cathode as a counter electrode while causing an electrolyte to come in contact with the anode and the cathode, the polishing pad comprising:
a plurality of electrolytic cells formed by the anode, the cathode, and the electrolyte and having a contact surface smaller than the device wafer, the electrolytic cells being moved relative to the interconnect material when electrolytically polishing the interconnect material on the device wafer.

2. The polishing pad as defined in claim 1, comprising:
a plurality of electrolyte reception sections disposed between the anode and the cathode and filled with the electrolyte so that the electrolyte comes in contact with the anode and the cathode, the electrolyte reception sections forming the electrolytic cells.

3. The polishing pad as defined in claim 2, comprising:
an insulating member having a plurality of openings; and
a conductive top layer provided on the insulating member and having a plurality of openings communicating with the openings in the insulating member;
wherein the electrolyte reception section is formed by the opening in the insulating member and the opening in the conductive top layer.

4. The polishing pad as defined in claim 3, comprising:
a conductive bottom layer provided on the insulating member on a side opposite to the conductive top layer.

5. The polishing pad as defined in claim 3, wherein the conductive top layer includes a polishing material.

6. The polishing pad as defined in claim 3, wherein the insulating member has a thickness of 0.5 to 5 mm.

7. The polishing pad as defined in claim 3,
wherein a positive electrode of a direct-current power supply is connected with the conductive top layer, and the interconnect material is caused to function as the anode by causing the conductive top layer to be electrically connected with the interconnect material on the device wafer.

8. A polishing method for electrolytically polishing an interconnect material on a device wafer by applying a direct-current voltage to the interconnect material as an anode and a cathode as a counter electrode while causing an electrolyte to come in contact with the anode and the cathode, the method comprising:
forming a plurality of electrolytic cells having a contact surface smaller than the device wafer using the anode, the cathode, and the electrolyte; and
electrolytically polishing the interconnect material on the device wafer while relatively moving the electrolytic cells and the interconnect material.

9. The polishing method as defined in claim 8, comprising:
using a polishing pad including a plurality of electrolyte reception sections forming the electrolytic cells.

10. The polishing method as defined in claim 9, comprising:
placing the polishing pad on a platen of a polishing device; and
supplying the electrolyte to the polishing pad.

11. The polishing method as defined in claim 10, comprising:
rotating the platen and a polishing head of the polishing device while causing the interconnect material on the device wafer secured to the polishing head to come in contact with the electrolytic cells.

12. The polishing method as defined in claim 10, comprising:
electrolytically polishing the interconnect material while supplying a direct current by applying a positive potential to an electrode in contact with the polishing pad and applying a negative potential to the platen.

13. The polishing method as defined in claim 8, wherein the electrolyte includes a polishing material dispersed therein.
